(19) United States
(12) Patent Application Publication
(10) Pub. No.: US 2015/0149249 A1
(43) Pub. Date: May 28, 2015

(54) METHODS AND SYSTEMS FOR ENERGY ARBITRAGE

(71) Applicant: The PowerWise Group, Inc., Boca Raton, FL (US)

(72) Inventor: Stephen Kenneth MANSFIELD, Wellington, FL (US)

(21) Appl. No.: 14/551,984

(22) Filed: Nov. 24, 2014

Related U.S. Application Data
(60) Provisional application No. 61/907,728, filed on Nov. 22, 2013.

(51) Int. Cl. G06Q 30/02; G06Q 50/06

(52) U.S. Cl. CPC G06Q 30/0205; G06Q 30/0241; G06Q 50/06
USPC 705/7.31

(57) ABSTRACT

A system and method are provided for performing energy arbitrage among different pre-defined regions. The system includes a plurality of power management devices within the different pre-defined regions to obtain power consumption data from corresponding customer facilities. An arbitrage server communicates with the plurality of power management devices and aggregates the power consumption data for the plurality of power management devices to determine a total power consumed within a same pre-defined region and obtains energy supply data to determine a total power supplied to the same pre-defined region. The arbitrage server further compares the total power consumed and the total power supplied within the same pre-defined region and performs one of offering to sell energy to a different pre-defined region when the total power supplied exceeds the total power consumed or offering to purchase energy from the different pre-defined region when the total power consumed exceeds the total power supplied.

### CROSS-REFERENCE TO RELATED APPLICATIONS

This application claims priority to U.S. Provisional Application 61/907,728, filed Nov. 22, 2013, the complete disclosure of which is incorporated herein by reference in its entirety.

### FIELD

The present disclosure relates generally to electric energy and more particularly to predicting energy usage and managing energy distribution in substantially real-time. Still more particularly, the present disclosure relates to predicting energy usage and managing energy distribution in substantially real-time based on data gathered from customer locations.

### BACKGROUND

Electricity is a use or lose commodity, so electric utility companies attempt to generate and distribute electricity based on actual energy demand predictions. Electric power meters are periodically read at customer locations to measure actual energy demands over preselected time periods. Additionally, mathematical models may be employed to predict future energy demands based on dynamic factors such as weather, temperature, time of day, and occurrence of large-scale events.

From a perspective of electricity consumers, a need exists to improve electricity pricing. Generally, electricity customers (i.e., ratepayers) are limited to purchasing electricity from a regional electricity provider such as a local utility company. Regulations have passed in about 31 states that allow specific groups of ratepayers to purchase electricity from outside their regional utility company such as from a non-regional utility company.

For example, in Florida, a ratepayer may purchase electricity from a utility company in North Carolina under certain circumstances in order to meet increased consumption needs that exceed the capacity of the Florida utility company. In most cases, this specific group of ratepayers is limited to large commercial ratepayers.

Many regions within the United States (U.S.) experience energy supply shortages due to routine equipment failures. In other regions, however, the nature of the energy supply shortage is due to electricity generation facilities, such as nuclear reactors, becoming deactivated for one reason or another. In areas where energy supplies are limited, utility companies often purchase additional energy capacity from other utility companies that may have excess capacity.

By way of example, a large information technology (IT) company may consume roughly thousands of kilowatts per day in a Boca Raton, Fla. facility. Such an enormous demand for power, when combined with other more typical energy demands, could exceed the capacity of the regional utility company. For this reason, many regional utility companies permit certain of their large commercial rate payers to purchase energy from non-regional providers. In fact, in states that permit the purchase of non-regional energy capacity, many regional providers may likely incorporate the additional capacity, created through use of the additional non-regional suppliers, into their overall energy production plan.

Accordingly, conventional systems only allow large volume energy customers to arbitrage energy and only on a limited basis. For example, large consumers typically can select individual energy suppliers and negotiate long term contracts for energy. However, as the energy markets dynamically change, the large customer is locked into a single contract with a single energy provider.

Even in regions where the appropriate regulatory and oversight organizations permit ratepayers to purchase energy from non-regional utility suppliers, many technical challenges exist. For example, conventional systems are deficient in (i) accurately measuring available energy capacity against instantaneous demands (e.g., power usage), (ii) determining and/or forecasting appropriate pricing models, and (iii) efficiently facilitating the purchase of energy (e.g., arbitraging) from non-regional utility companies when demand exceeds capacity.

By way of background, when energy demands exceed the available capacity of a regional energy supplier, abatement measures, such as brownouts and rolling blackouts, are often used to arbitrarily curb the demand to match the available energy capacity. However, the arbitrary nature in which these abatement measures are implemented can create unanticipated and unnecessary service interruptions.

Conventional energy delivery measurement and analysis tools are ineffective at reliably predicting and compensating for these increased energy demands. More particularly, conventional systems are completely unable to compensate for these rolling blackouts, triggered by increased demand, in a manner transparent to the ratepayers.

A byproduct of greater reliably in predicting increased energy demands and/or capacity is the creation of more accurate energy forecast modeling. More accurate forecast modeling ultimately translates to greater certainty within the energy futures market. Currently, however, there are no mechanisms to provide reliable and accurate prediction of increased energy demands and/or capacity. Accordingly, there is a substantial delay between detecting electricity demand changes and adjusting electricity generation.

Given the inefficiencies in existing electricity supply and demand models, electric utility companies typically compensate by generating around 90% of electricity demand predictions and purchasing the remaining 10% of electricity demand predictions from other electric utility companies. From a cost perspective, electric utility companies typically spend 2 to 4 times more to distribute the last 10% of supplied electricity as compared to the generated 90% of the supplied electricity.

### SUMMARY

Given the aforementioned deficiencies, a need exists for methods and systems that reliably predict and compensate for variations in energy demands. A need also exists for methods and systems that provide more accurate energy forecast models, including predicting electricity demand on a substantially continuous basis. Furthermore, what is needed is an improved system and method of matching energy supply with the predicted electricity demand in substantially real-time. Additionally, what is needed is an improved system and method that enables electric utility companies to generate greater than 90% of the predicted electricity demand.

According to one example, a system is provided for performing energy arbitrage among different pre-defined regions. The system includes a plurality of power management devices within the different pre-defined regions to obtain power consumption data from corresponding customer facilities. An arbitrage server communicates with the plurality of power management devices and aggregates the power consumption data for the plurality of power management devices to determine a total power consumed within a same pre-defined region and obtains energy supply data to determine a total power supplied to the same pre-defined region. The arbitrage server further compares the total power consumed and the total power supplied within the same pre-defined region and performs one of offering to sell energy to a different pre-defined region when the total power supplied exceeds the total power consumed or offering to purchase energy from the different pre-defined region when the total power consumed exceeds the total power supplied.

According to another example, a computer-implemented method is provided for performing energy arbitrage among different pre-defined regions. The method includes obtaining, via a processor, power consumption data from corresponding customer facilities located within the different pre-defined regions and aggregating the power consumption data associated with a plurality of power management devices to determine a total power consumed within a same pre-defined region. Energy supply data is obtained to determine a total power supplied to the same pre-defined region and the total power consumed and the total power supplied are compared within the same pre-defined region. When the total power supplied exceeds the total power consumed an offer may be made to sell energy to a different pre-defined region. When the total power consumed exceeds the total power supplied an offer may be made to purchase energy from the different pre-defined region.

According to yet another example, a non-transitory computer-readable storage medium is provided having stored therein instructions which, when executed by an electronic device, cause the electronic device to obtain, via a processor, power consumption data from corresponding customer facilities located within the different pre-defined regions and aggregate the power consumption data associated with a plurality of power management devices to determine a total power consumed within a same pre-defined region. Energy supply data is obtained to determine a total power supplied to the same pre-defined region and the total power consumed and the total power supplied are compared within the same pre-defined region. When the total power supplied exceeds the total power consumed an offer may be made to sell energy to a different pre-defined region. When the total power consumed exceeds the total power supplied an offer may be made to purchase energy from the different pre-defined region.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

Implementations of the present technology will now be described, by way of example only, with reference to the attached figures, wherein:

FIG. 1 illustrates a smart-grid environment according to one example of the disclosure;

FIG. 2 illustrates a smart-grid environment according to another example of the disclosure;

FIG. 3 illustrates a smart-grid environment according to yet another example of the disclosure;

FIG. 4 illustrates a flowchart of an example method according to the present disclosure.

FIG. 5 illustrates a table identifying U.S. states that allow competitive sales of electricity from a non-local electric utility.

FIG. 6 is a graphical illustration depicting the overall growth in electrical energy purchasing outside the local power utility.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. Those skilled in the art with access to the teachings provided herein will recognize additional modifications, applications, and embodiments within the scope thereof and additional fields in which the invention would be of significant utility.

Unless defined otherwise, technical and scientific terms used herein have the same meaning as is commonly understood by one of ordinary skill in the art to which this disclosure belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either, any, several, or all of the listed items.

The terms “connected” and “coupled” are not restricted to physical or mechanical connections or couplings, and can include electrical connections or couplings, whether direct or indirect. The connection can be such that the objects are permanently connected or releasably connected. The term “communicatively coupled” is defined as connected, either directly or indirectly through intervening components, and the connections are not necessarily limited to physical connections, but are connections that accommodate the transfer of data, fluids, or other matter between the so-described components. The term “substantially” is defined to be essentially conforming to the thing that it “substantially” modifies, such that the thing need not be exact. For example, substantially real-time means that the occurrence may happen without noticeable delay, but may include a slight delay.

The terms “circuit,” “circuitry,” and “controller” may include either a single component or a plurality of components, which are either active and/or passive components and may be optionally connected or otherwise coupled together to provide the described function. The “processor” described in any of the various embodiments includes an electronic circuit that can make determinations based upon inputs and is interchangeable with the term “controller.” The processor can include a microprocessor, a microcontroller, and a central processing unit, among others, of a general purpose computer, special purpose computer, ASIC, or other programmable data processing apparatus. While a single processor can be used, the present disclosure can be implemented over a plurality of processors.

The “server” described in any of the various embodiments includes hardware and/or software that provides processing, database, and communication facilities. By way of example, and not limitation, “server” may refer to a single, physical processor with associated communications and data storage and database facilities, or it can refer to a networked or clustered complex of processors and associated network and storage devices, as well as operating software and one or more database systems and applications software that support the services provided by the server.

The phrase “electric utility company” is defined as an entity that provides or manages the supply of electrical power or energy to one or more energy customers. The phrase as used in this disclosure encompasses, without limitation, regional utility companies, regional transmission organizations, and any other load servicing entities or entities that manage the power grid within a geographical area. Energy customers may be any entity that uses electrical power for any purpose. For example, energy customer may include, without limitation, individual home owners, commercial office building tenants, manufacturing operations personnel, or the like.

For the purposes of this disclosure a computer readable medium stores computer data in machine readable form. By way of example, and not limitation, the computer readable medium may include computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium that may be used to store the desired information and which can be accessed by the computer.

The terms “comprising,” “including” and “having” are used interchangeably in this disclosure. The terms “comprising,” “including” and “having” mean to include, but not necessarily be limited to the things so described.

The below description references block diagrams and operational illustrations of methods and devices for predicting energy usage and managing energy distribution. It is understood that each block of the block diagrams or operational illustrations, and combinations of blocks in the block diagrams or operational illustrations, can be implemented with analog or digital hardware and computer program instructions. The computer program instructions may be provided to a processor that executes the computer program instructions to implement the functions/acts specified in the block diagrams or operational block or blocks. In some alternative implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

The systems and methods described herein utilize demand-side monitoring and/or supply-side monitoring to minimize differences between supply and demand for electricity. Demand-side monitoring includes, for example, monitoring demand for energy at a plurality of consumption points such as customer facilities. Supply-side monitoring includes, for example, monitoring an aggregate demand for energy associated with the plurality of consumption points in pre-defined regions and monitoring a supply of energy to be delivered to the consumption points within the pre-defined regions.

With respect to the demand-side monitoring, a power management device may be provided at the consumption point to monitor and report energy demand or usage. According to one example, the power management device may be programmed to monitor and report energy usage in substantially real-time. With respect to the supply-side monitoring, an arbitrage server may be communicatively coupled to a plurality of power management devices to monitor energy usage in aggregate. For example, energy usage may be monitored in aggregate according to pre-define regions. Additionally, the arbitrage server may be communicatively coupled to interface devices associated with electric utility companies, the interface devices reporting an energy supply in substantially real-time.

According to one example, when aggregate electricity demand is mismatched with corresponding electricity supply within pre-defined regions, the arbitrage server may arbitrage electricity between different pre-defined regions in order to match electricity demand and electricity supply within the pre-defined regions. For example, when aggregate electricity demand exceeds electricity supply within a first pre-defined region, the arbitrage server may arbitrage electricity from other pre-defined regions in order to match electricity demand with electricity supply within the first pre-defined region. Alternatively, when electricity supply exceeds aggregate electricity demand in the first pre-defined region, the arbitrage server may arbitrage electricity to different pre-defined regions in order to match electricity demand with electricity supply within the first pre-defined region. Accordingly, this disclosure provides systems and methods for correcting a mismatch of electricity demand and electricity supply within pre-defined regions.

Traditionally, electricity customers activate an account with a local electric utility company and are billed on a regular basis such as monthly for electricity consumed the previous month. Currently, electricity customers are not able to arbitrage energy from other sources, such as other electric utility companies. Examples described herein provide systems and methods that enable customers to arbitrage energy from two or more energy sources such as two or more electric utility companies. As described below, the systems and methods further enable an electric utility company to manage energy supply requirements by building real-time models of demand versus supply. Still further, the systems and methods described herein enable customers such as individuals, small businesses, and large businesses to select a low cost energy consumption model based on establishing a real-time preference profile.

Systems and methods described herein enable energy arbitrage trading companies to efficiently buy energy from electric utility companies and sell energy to electricity customers and electric utility companies. Still further, the electric utility companies may use the data gathering capabilities to more efficiently generate, buy, and sell energy to energy customers and other electric utility companies.

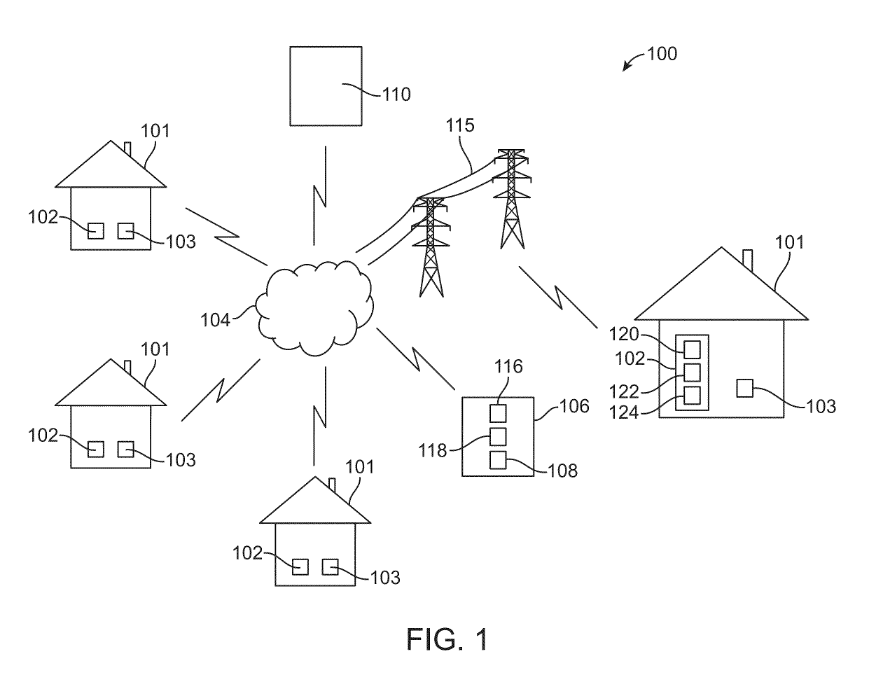

FIG. 1 illustrates one example of a smart-grid environment 100. A customer facility 101 such as a residential building, a commercial building, or the like, is provided with energy consuming devices. For example, the energy consuming devices may include computers, refrigerators, televisions, climate control systems such as heating and air conditioning systems, motors, pumps, commercial or manufacturing devices, or the like. According to one example, a plurality of power management devices 102 may be provided at the customer facilities 101. The plurality of power management devices 102 may be communicatively coupled to the energy consuming devices within the corresponding customer facility 101.

The power management device 102 may be communicatively coupled to a power meter 103 provided at the customer facility 101. Power is transmitted to the customer facility 101 over transmission lines 115 that form part of a power grid. According to one example, the power management device 102 may be communicatively coupled to the smart grid environment 100 via a network 104 such as the Internet, a cellular communications network, a private wide area network (“WAN”), a power line communications (“PLC”) network, or any other suitable communications technology. The network 104 may be connected to the Internet via conventional routers and/or firewalls. The network 104 also may be connected to a common carrier wireless network such as a CDMA network. The network 104 also may be connected to a wide area network that is connected to the PLC network.

The power management device 102 may include an onboard computer having a processor 120 and may be communicatively coupled to a computer readable media 122. The power management devices 102 may include a display device 124 having a graphical user interface that enables customers to control the power management device 102. Alternatively, the power management devices 102 may be remotely controlled by a customer computer via the network 104. Still further, the power management devices 102 may be remotely controlled by the electric utility company or other third party via the network 104. Software applications are provided at the power management device 102 for interfacing with the power meter 103, the energy consuming devices, and an application server 106 described below, among other components. The software applications may include instructions that are executed by the processor 120.

The power meter 103 is provided at the customer facilities 101 to measure power consumed by the energy consuming devices therein. According to one example, the power meter 103 may be furnished by the electric utility company that services the corresponding customer facility 101. Alternatively, the power meter 103 may be furnished by an entity that is different from the electric utility company. In this case, the power meter 103 may replace any power meter furnished by the electric utility company. Alternatively, the power meter 103 may be communicatively coupled to a power meter furnished by the electric utility company, such as being communicatively coupled in serial fashion. Power may enter the customer facility 101 via the power meter 103 and the power management device 102.

According to one example, the power meter 103 may be programmed to measure power consumption in substantially real-time. Accordingly, the power meter 103 may measure the power consumed at the customer facility 101 in substantially real-time and may communicate power consumption data to the power management device 102 at preselected intervals. The computer readable media 122 may store data such as the power consumption data or may provide backup or archive for the data received at the power management device 102. The preselected intervals may include time intervals such as real-time or continuous, seconds-based, minute-based, hours-based, day-based, month-based, or the like. One of ordinary skill in the art will readily appreciate that other preselected intervals may include intervals triggered by a percentage change in energy consumption, an aggregated amount of energy consumed, a time of day, a day of a month, or the like. One of ordinary skill in the art also will readily appreciate that the power management devices 102 and the power meters 103 may be provided in a combined unit or may be provided as separate units.

Referring to FIG. 1, an application server 106 may be provided that communicates with the plurality of power management devices 102. The application server 106 may communicate with the plurality of power management devices 102 via a network 104 such as the Internet, a cellular communications network, a private WAN, a PLC network, or any other suitable communications technology. According to one example, the network may be associated with a preselected area. For example, the network may be associated with a geographic area such as a street, a neighborhood, a zip code, a county, a state, a region, or the like. The plurality of power management devices 102 may be assigned an Internet Protocol (IP) address to track corresponding location information. One of ordinary skill in the art will readily appreciate that other technology may be used to obtain location information.

The application server 106 may include an onboard computer having a processor 116 that is communicatively coupled to a computer readable media 118 that stores data such as in a database. The application server 106 may include a display device having a graphical user interface that enables the electric utility company to control the application server 106. Alternatively, the application server 106 may be remotely controlled by the electric utility company or other third party via the network 104. Software applications are provided at the application server 106 for interfacing with the power management device 102, the power meter 103, and the energy consuming devices, among other components. The software applications may include instructions that are executed by the processor 116.

According to one example, the power management device 102 may communicate with the power meter 103 and the application server 106 via the network 104. The network 104 may support a transmission control protocol/Internet protocol (TCP/IP) connection, for example, and may be accessed over a cellular communications channel, wi-fi, a wired connection, or the like. Once the connection is established, an application may communicate and control the power management devices 102 to obtain energy consumption data in real-time. The energy consumption data received from all other power management devices 102 may be aggregated to develop an instantaneous aggregate energy demand profile.

According to one example, the power management device 102 may communicate with a corresponding application server 106 to provide customer facility data such as an amount of power consumed at the customer facility 101, types of energy consuming devices at the customer facility 101, whether the customer facility 101 is occupied or vacant, preferred temperature settings for the climate control system, or the like. The computer readable media 118 may store data such as the customer facility data or may provide backup or archiving for the data received at the application server 106. At preselected intervals, the plurality of power management devices 102 may communicate the customer facility data to the corresponding application server 106. For example, the preselected intervals may include time intervals such as real-time or continuous, seconds-based, minute-based, hours-based, day-based, month-based, or the like. One of ordinary skill in the art will readily appreciate that other preselected intervals may include intervals triggered by a percentage change in energy consumption, an aggregated amount of energy consumed, a time of day, a day of a month, or the like.

According to one example, t a software application 108 (hereinafter “application 108”) may interface with the application server 106 to access the customer facility data. For example, the application 108 may include instructions that are executed on a processor to aggregate the customer facility data for analysis. According to one example, the application 108 may analyze the aggregated customer facility data obtained from the plurality of power management devices 102 to determine aggregated energy usage. The aggregated energy usage may be determined over any time period such as instantaneously, over an hourly period, a daily period, a weekly period, a monthly period, or the like. Furthermore, the application 108 may analyze additional data during the corresponding time period. The additional data may include environmental data, weather data, or the like. According to one example, the application 108 may analyze the aggregated energy usage and/or the additional data to predict future energy usage over a pre-selected time period.

According to one example, the application 108 may reside in the computer readable media 118 of the application server 106. Alternatively, the application 108 may reside at a remote client device 110 that is communicatively coupled to the application server 106. The remote client device 110 may communicate with the application server 106 via a network 112. The network 112 may support a TCP/IP connection, for example, via the Internet, a cellular communications network, a private WAN, a PLC network, or any other suitable communications technology. The network 112 may be connected to the Internet via conventional routers and/or firewalls. The network 112 also may be connected to a common carrier wireless network such as a CDMA network. The network 112 also may be connected to a wide area network that is connected to the PLC network.

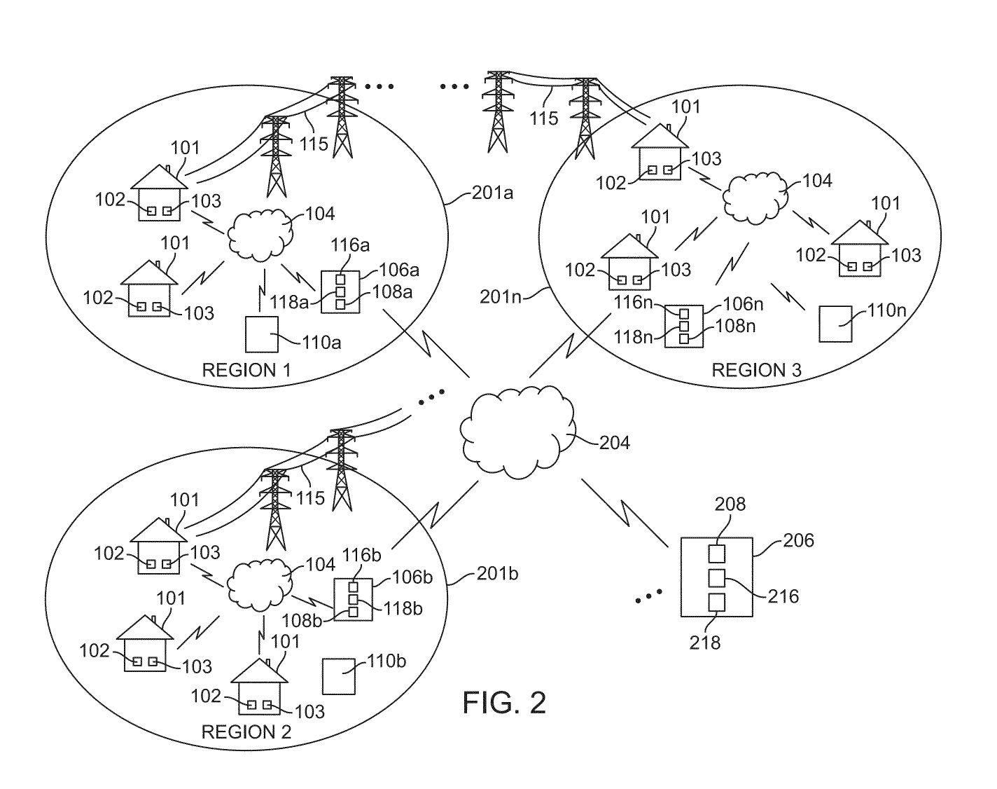

With reference to FIG. 2, a plurality of regions 201a-201n may be defined, with each group including components illustrated in FIG. 1. The plurality of regions 201a-201n may be defined according to geographic area such as a street, a neighborhood, a zip code, a county, a state, a region, or the like. Alternatively, the plurality of regions 201a-201n may be defined according to a customer type such as residential customers, commercial customers, industrial customers, hospitals, police stations, emergency response units, or the like. One of ordinary skill in the art will readily appreciate that the plurality of regions 201a-201n may have any desired characteristics.

According to one example, the plurality of regions 201a-201n may define customers within selected geographical counties. A plurality of customer facilities 101 provided with the power management device 102 and the power meter 103 as described above may be associated with the corresponding plurality of regions 201a-201n. Furthermore, the application servers 106a-106n may be associated with the corresponding plurality of regions 201a-201n and may communicate with the plurality of power management devices 102 as described above. Alternatively, one of ordinary skill in the art will readily appreciate that an application server 206 may be associated with two or more of the plurality of regions 201a-201n.

The application server 206 may include an onboard computer having a processor 216 that is communicatively coupled to a computer readable media 218 that stores data such as in a database. The application server 206 may include a display device having a graphical user interface that enables the electric utility company to control the application server 206. Alternatively, the application server 206 may be remotely controlled by the electric utility company via the network 204. Software applications are provided at the application server 206 for interfacing with the power management device 102, power meter 103, the application servers 106a-106n, and the energy consuming devices. The software applications may include instructions that are executed by the processor 216.

A network 204 may be provided to communicatively couple the plurality of regions 201a-201n and the application server 206. The network 204 may support a TCP/IP connection, for example, via the Internet, a cellular communications network, a private WAN, a PLC network, or any other suitable communications technology. The network 204 may be connected to the Internet via conventional routers and/or firewalls. The network 204 also may be connected to a common carrier wireless network such as a CDMA network. The network 204 also may be connected to a wide area network that is connected to the PLC network. A software application 208 (hereinafter “application 208”) may interface with the application server 206 to access the customer facility data obtained from the plurality of regions 201a-201n.

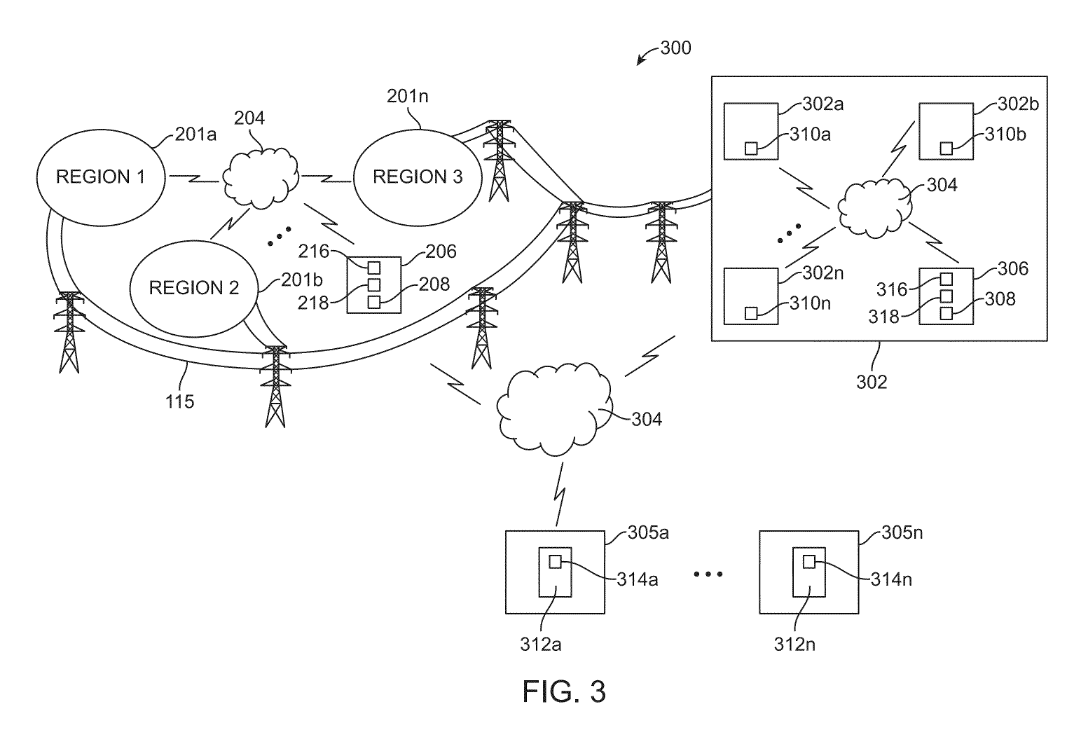

FIG. 3 illustrates an energy arbitrage system 300 according to one example. The energy arbitrage system 300 includes the plurality of regions 201a-201n and the application server 206 as described above with reference to FIG. 2 and may include the components described above with reference to FIG. 1. The electricity distribution system 115 is provided to transport energy from one or more generation facilities 302 to the customer facilities 101 provided at the plurality of regions 201a-201n. The power management devices 102 are installed at the customer facilities 101 regions and obtain data defining a customer's energy consumption profile. According to one example, the power management devices 102 are configured to transmit the corresponding data to the application server 206, the application server 306, and/or the application servers 106a-106n. The generation facilities 302 may include green energy generation facilities, nuclear energy generation facilities, hydroelectric energy generation facilities, and low cost energy generation facilities, among other types of generation facilities. For example, the generation facilities 302 may include coal-based generation facilities 302a, natural gas-based generation facilities 302b, and solar-based generation facilities 302n, among other generation facilities.

The generation facilities 302a-302n may include a corresponding interface device 310a-310n that is communicatively coupled to the application server 206 and/or the application servers 106a-106n. Alternatively or additionally, the generation facilities 302a-302n may be communicatively coupled to an application server 306 via a network 304. The network 304 may be connected to the Internet via conventional routers and/or firewalls. The network 304 also may be connected to a common carrier wireless network such as a CDMA network. The network 304 also may be connected to a wide area network that is connected to the PLC network.

The application server 306 may include an onboard computer having a processor 316 that is communicatively coupled to a computer readable media 318 that stores data such as in a database. The application server 306 may include a display device having a graphical user interface that enables the electric utility company to control the application server 306. Alternatively, the application server 306 may be remotely controlled by the electric utility company or other third party via the network 304. Software applications are provided at the application server 306 for interfacing with the power management device 102, the power meter 103, the application servers 106a-106, the application server 206, and the energy consuming devices, among other components. The software applications may include instructions that are executed by the processor 316. A software application 308 (hereinafter “application 308”) may reside in the application server 306. The application server 306 may be communicatively coupled to the application server 206 and/or the application servers 106a-106n via the network 304 and/or network 204.

According to one example, each generation facility 302a-302n may be assigned to one or more corresponding regions 201a-201n. The interface devices 310a-310n may communicate with the application server 206 and/or the corresponding application servers 106a-106n to obtain and/or determine, for example, the customer's energy demand profile and energy preference profile. Furthermore, the interface devices 310a-310n may analyze the energy demand needs of the corresponding regions 201a-201n. For example, the interface devices 310a-310n may access and analyze the customer facility data obtained from the application servers 106a-106n, 206. The analysis may be performed in substantially real-time and may be relied upon by the corresponding generation facility 302a-302n to determine how much energy to generate. In this way, the generation facilities 302a-302n may attempt to accurately align energy generation or supply with power demand.

Typically, a generation facility may attempt to generate or purchase in advance from other generation facilities approximately 90% of expected power demand. The remaining 10% of expected power demand is typically purchased on a spot market from the other generation facilities. The technology described herein provides a system and method for improving energy consumption predictions thereby enabling a generation facility to generate or purchase in advance greater than 95% of expected power demand. This leaves less than 5% of expected remaining power demand to be purchased on the spot market from other generation facilities. Accordingly, the technology described herein provides substantial cost savings to energy generation facilities over existing technology. As a point of reference, a generation facility may generate energy or purchase in advance greater than 95% of expected power demand at an approximate cost of 3-7¢ per kilowatt/hour. By contrast, the generation facility may purchase less than 5% of energy on a spot market at a cost of approximately 14¢ per kilowatt/hour.

According to another example, the systems and methods described herein enable arbitrage servers 305a-305n associated with third-party energy trading entities to analyze data obtained from data sources such as the application servers 106a-106n, 206, 306, the interface devices 310-310n, and the power management devices 102, among other data sources. For example, the arbitrage servers 305a-305n may aggregate and analyze power consumption data obtained from one or more of the regions 201a-201n to predict power demand in the corresponding regions 201a-201n. The arbitrage servers 305a-305n also may communicate with the interface devices 310a-310n to obtain energy supply data corresponding to the generation facilities 302a-302n.

After analyzing the power consumption data and the energy supply data, the third-party energy trading entities may efficiently purchase energy from generation facilities 302a-302n and sell energy to the customer facilities 101 and other generation facilities 302a-302n. According to one example, the arbitrage servers 305a-305n may include communication devices 312a-312n having corresponding applications 314a-314n for communicating with the application servers 106a-106n, 206, 306, the interface devices 310-310n, and the power management devices 102, among other data sources, to analyze energy demands of the corresponding regions 201a-201n. For example, the communication devices 312a-312n may access and analyze the power consumption data stored at the application servers 106a-106n, 206, 306. The arbitrage servers 305a-305n may analyze the power consumption data in substantially real-time. The third-party energy trading entities may rely upon the power consumption data to determine how much energy to purchase from the generation facilities 302a-302n. In this way, the third-party energy trading entities may attempt to accurately align energy purchases with power demands of customer facilities 101 and other generation facilities 302a-302n.

The communication devices 312a-312n may include an onboard computer having a processor and may be communicatively coupled to a computer readable media. The communication devices 312a-312n may include a display device having a graphical user interface that enables the third-party energy trading entities to accurately align energy purchases with power demands of customer facilities 101. The arbitrage servers 305a-305n may be programmed to control the plurality of power management devices 102 via the network 304. Software applications may be provided at the power management device 102 to interface with the arbitrage servers 305a-305n, among other components. The software applications may include instructions that are executed by the processor.

As described above, the plurality of power management devices 102 may include a graphical user interface that enables users or customers to select energy purchasing preferences. For example, the power management devices 102 may enable users to select a type of energy to purchase, including green energy, nuclear energy, hydroelectric energy, coal energy, low cost energy, and low emission energy, among other types of energy. Furthermore, the power management devices 102 enable users to select a cost range for purchasing power. For example, users may select among different cost ranges such as 3-5¢ per Kw/hr for coal-based energy, 4-6¢ per Kw/hr for natural gas based energy, 5-6¢ per Kw/hr for wind-based energy, 6-8¢ per Kw/hr for solar-based energy, or the like. The arbitrage servers 305a-305n may arbitrage with the application servers 106a-106n, 206, 306, the interface devices 310-310n, and the power management devices 102, among other data sources, to obtain low cost energy that matches a customer's demand and energy purchasing preferences. One of ordinary skill in the art will readily appreciate that customers may select other energy purchasing preferences. Accordingly, the energy arbitrage system 300 enables third-party energy trading entities and generation facilities 302a-302n to offer energy purchasing options that match a customer's energy purchasing preferences.

The energy arbitrage system 300 provides an energy market for the customer facilities 101 and generation facilities 302a-302n to maximize savings and/or customize energy purchase preferences, while providing an opportunity for the generation facilities 302 and the third-party energy trading entities to maximize profits. One of ordinary skill in the art will readily appreciate that the generation facilities 302 also may be the third-party energy trading entities and customers. From a perspective of the customer facilities 101, the energy arbitrage system 300 provides demand-side monitoring via the power management devices 102 that allow customers to support a desired technology by, for example, limiting energy purchases to the desired technology such as solar energy, wind energy, or the like. Even if customers initially pay higher fees for solar energy, increased market demand for solar energy may shift research and development efforts to eventually offer solar energy at competitive rates.

From a perspective of the generation facilities 302, the energy arbitrage system 300 provides supply-side monitoring by providing accurate tools for predicting actual instantaneous demand. Accordingly, the generation facilities 302 may generate electricity closer to 100% of their customer energy demands. In this way, the need to purchase energy from other generation facilities 302 on a spot market may be substantially reduced, thereby maximizing profits.

From a perspective of the third-party energy trading entities, the energy arbitrage system 300 provides supply-side monitoring that includes offering a broader market to purchase and sell energy. According to one example, the application servers 106a-106n, 206, 306 may bundle customer preferences together from different regions to develop an overall energy preference profile. The overall energy preference profile may be used to purchase electrical energy for distribution over the different regions by different energy arbitrage providers such as different generation facilities 302. The energy may be purchased in bulk and then may be sliced and distributed to individual customers at energy cost savings.

Additionally, based on obtaining accurate energy preference profiles, the arbitrage servers 305a-305n may delay and purchase energy from generation facilities 302 just prior to the energy becoming wasted, for example. In this case, the arbitrage servers 305a-305n may purchase the energy at heavily discounted rates. Upon purchase, the arbitrage servers 305a-305n may instantaneously distribute this energy at or below market rates to customer facilities 101 over the plurality of regions 201a-201n. Alternatively, the arbitrage servers 305a-305n may instantaneously distribute the energy at or above market rates to other generation facilities 302 that may be in need of additional energy supply such as to avoid operating in brown out and/or blackout conditions.

The energy trading industry is governed by technical standards that allow for automatic electronic energy trading. One of ordinary skill in the art will readily appreciate that energy trading may be performed electronically to enable substantially instantaneous purchase and distribution of energy. The arbitrage servers 305a-305n may be programmed to automate data gathering, power modeling based on the gathered data, bundling of total power needs based on the modeled power needs, arbitraging for low cost energy, and distributing and billing customers for distributing the electrical energy, or the like. The energy arbitrage system 300 may be cost effective to implement and may provide a valuable service to its customers.

The energy arbitrage system 300 may predict energy usage and manage energy distribution in substantially real-time based on data gathered from customer locations. The energy arbitrage system 300 may include application servers 106a-106n, 206, 306 configured to (i) autonomously measure customer energy consumption at a location and (ii) create customer energy data in response to the measurement. The energy arbitrage system 300 also may include a utility management processor configured to (i) analyze the customer energy data and (ii) arbitrage within energy trading companies to purchase energy based upon the analyzed customer energy data.

The energy arbitrage system 300 allows customers to purchase electrical energy from an Internet-based energy arbitrage website. The energy arbitrage website may be configured to communicate with a power management device via wired or wireless connection. The power management devices 102 may be installed at customer premises to determine an instantaneous or a total energy used over a period. The data may be collected by the application servers 106a-106n, 206,306 and may be used to bill customers for energy usage.

Additionally, the energy arbitrage system 300 may employ demand-side monitoring tools to reduce overall energy costs. For example, the energy arbitrage system 300 may provide an interface for creating an energy consumption profile for the customer. The energy arbitrage system 300 may analyze the customer's energy consumption profile and select economical energy sources that may significantly lower energy costs. For example, based on a customer's energy consumption profile, the energy arbitrage system 300 may automatically purchase lower cost energy when provided with a choice of two or more energy sources. In this regards, the energy arbitrage system 300 may provide options that enable customers to select low cost and/or efficient energy production having minimal adverse impact on the environment. For example, customers may select green energy sources such as hydroelectric, photovoltaic, or geothermal energy sources. Individual customers can select energy sources that align with their energy needs and environmental principles.

The application servers 106a-106n, 206, 306 are programmed to enable customers to select or profile among different energy sources and to bundle customer energy demands when performing energy arbitrage modeling. Bundling of energy demand allows for a bulk purchase of low cost energy at the time of the arbitrage contract. Customer energy consumption profiling such as source profiling is an effective marketing tool for environmentally focused customers. Furthermore, allowing customers to source profile enables the application servers 106a-106n, 206, 306 to select energy sources and energy types that are in line with a customer's green footprint profile.

Examples described herein enable customers to instantaneously receive optimal energy pricing and alternatives. Furthermore, the energy arbitrage system 300 includes power management devices 102 that are programmed to monitor demand for energy at a point of consumption and may be employed to predict energy usage and manage energy distribution.

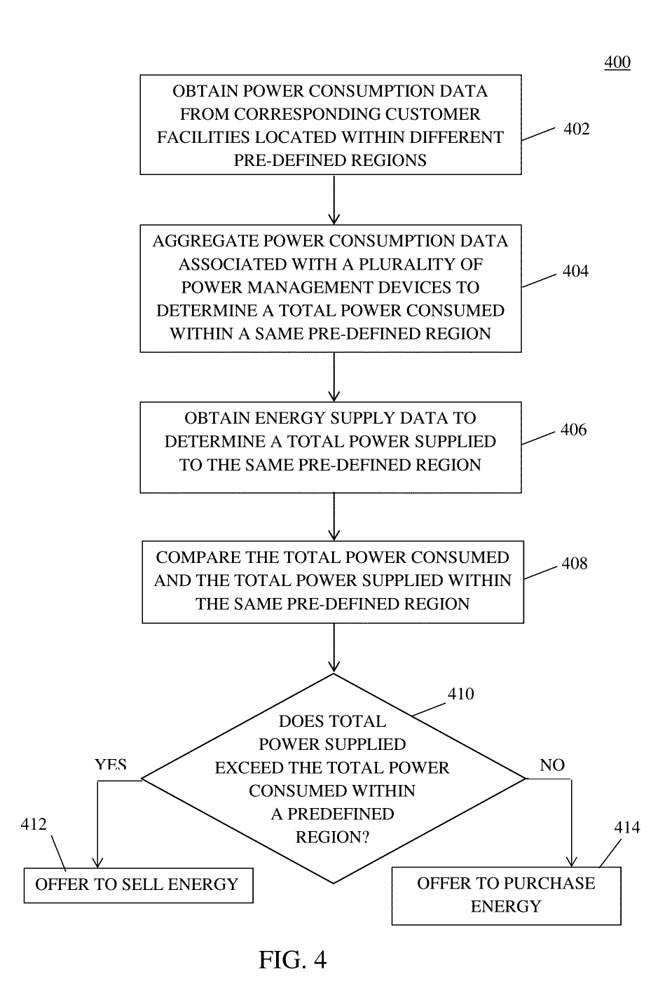

FIG. 4 is a flowchart of an example method 400 according to the present disclosure. The method 400 may be implemented using the above described systems. For example, the method 400 may be implemented using an energy arbitrage system such as a computer to buy and sell energy among different pre-defined regions based on substantially instantaneous predictions of energy demand within a pre-defined region.

The method 400 may include obtaining, via a processor, power consumption data from corresponding customer facilities 101 located within the different pre-defined regions 201a-201n (block 402). The customer facilities 101 may include residential buildings, commercial buildings, and industrial buildings, or the like, that are located within a pre-defined region 201a-201n and have energy consuming devices. The method 400 may further include aggregating the power consumption data associated with a plurality of power management devices 102 to determine a total power consumed within a same pre-defined region 201a-201n (block 404). For example, power management devices 102 may communicate the power consumption data to application servers 106a-106n, 206, 306. The energy arbitrage system 300 may be configured as described above. The method 400 also may include obtaining energy supply data to determine a total power supplied to the same pre-defined region 201a-201n (block 406). For example, the generation facilities 302a-302n may communicate energy supply data to the arbitrage servers 305a-305n in substantially real-time. Additionally, the method 400 may include comparing the total power consumed and the total power supplied within the same pre-defined region 201a-201n (block 408). The arbitrage servers 305a-305n may decide whether the total power supplied exceeds the total power consumed (block 410). If yes, then an offer may be made to sell energy to a different pre-defined region 201a-201n (block 412). If the total power consumed exceeds the total power supplied, then an offer may be made to purchase energy from the different pre-defined region 201a-201n (block 414).

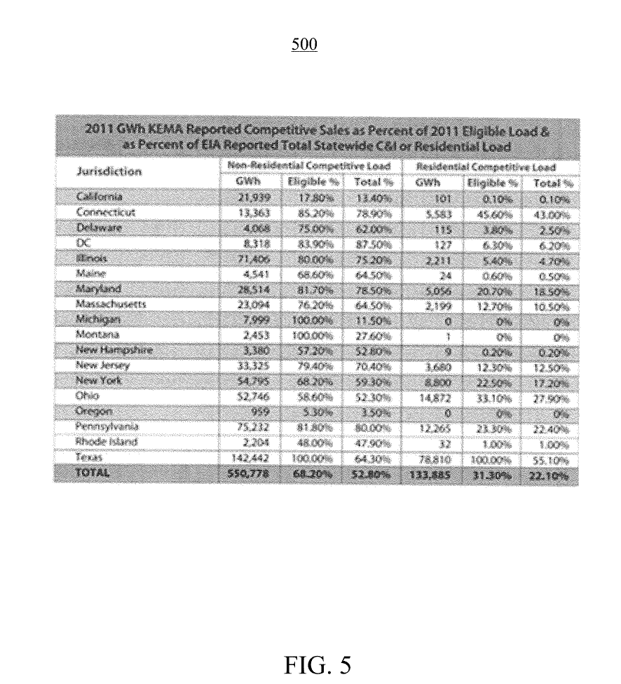

FIG. 5 illustrates a table 500 of states within the United States that allow competitive sales of electricity. For the columns falling under non-residential competitive load, the left column provides the Gigawatt Hour (“GWh”) value, the middle column provides an eligible percentage, and the right column provides a total percentage. For the columns falling under residential competitive load, the left column provides the GWh value, the middle column provides an eligible percentage, and the right column provides a total percentage . . . . The listed states have changed electric utility laws to allow customers to purchase power from sources other than from the local electric utility. More specifically, table 500 lists states that allowed purchase of electrical energy from sources outside of the local electric utility as of 2011. The table 500 identifies a percentage of non-residential and residential customers that purchased electric power from sources outside of the local electric utility as of 2011.

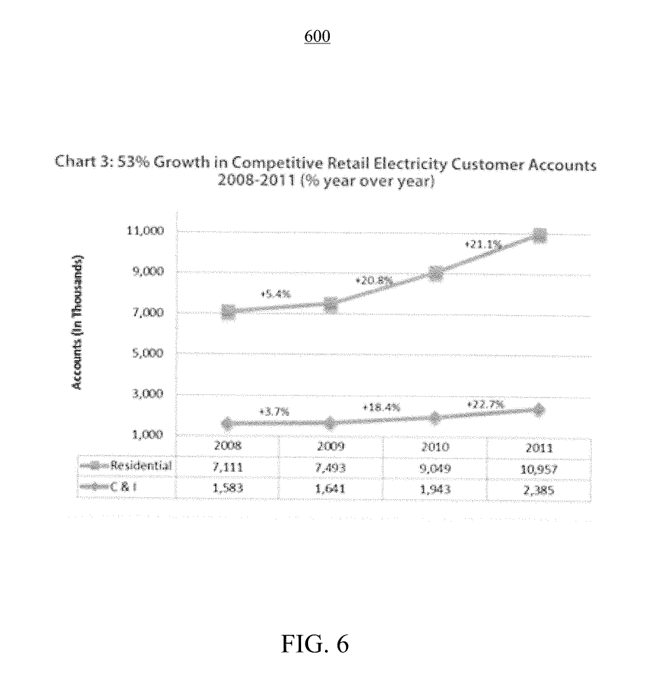

FIG. 6 illustrates a chart 600 depicting growth in competitive retail electricity customer accounts between 2008 and 2011 for residential and commercial/industrial (“C&I”).

As generally understood by those of skill in the art, lowest cost energy arbitraging is currently available only for the largest of commercial customers. To achieve such arbitraging, individual power companies must install proprietary electric meters and then read these electric meters individually. Thus, the currently available arbitraging is only advantageous for this small group of largest commercial customers.

Examples of energy arbitrage methods and systems are described for predicting energy usage and managing energy distribution in substantially real-time based on data gathered from customer locations. These profile models can be used for measuring real-time customer energy demand needs, instantaneously creating demand and profile models, and managing customer energy savings. Savings, for example, result from using less power during peak generation periods.

Embodiments also provide an ability to bundle many individual models and build a composite arbitrage demand model, arbitrage energy electronically energy needs, sell energy electronically to individual customers, and allow consumers to select their own energy source profiles and cost objectives.

Examples are described above with the aid of functional building blocks that illustrate the implementation of specified functions and relationships thereof. The boundaries of these functional building blocks have been arbitrarily defined herein for the convenience of the description. Alternate boundaries can be defined so long as the specified functions and relationships thereof are appropriately performed. It is to be appreciated that the Detailed Description section, and not the Summary and Abstract sections, is intended to be used to interpret the claims. The Summary and Abstract sections may set forth one or more but not all examples contemplated by the inventor(s), and thus, are not intended to limit the present disclosure and the appended claims in any way.

What is claimed is:

1. A system for performing energy arbitrage among different pre-defined regions, the system comprising:
a plurality of power management devices provided within the different pre-defined regions, the plurality of power management devices obtaining power consumption data from corresponding customer facilities located within the different pre-defined regions; and
an arbitrage server communicatively coupled to the plurality of power management devices provided within the different pre-defined regions, the arbitrage server including a processor that communicates with a computer-readable medium having instructions stored thereon that, when executed by the processor, cause the processor to:
aggregate the power consumption data for the plurality of power management devices to determine a total power consumed within a same pre-defined region;
obtain energy supply data to determine a total power supplied to the same pre-defined region;
compare the total power consumed and the total power supplied within the same pre-defined region;
offering to sell energy to a different pre-defined region when the total power supplied exceeds the total power consumed; and
offering to purchase energy from the different pre-defined region when the total power consumed exceeds the total power supplied.

2. The system according to claim 1, wherein the power management device obtains the power consumption data from the corresponding customer facilities in substantially real-time.

3. The system according to claim 1, wherein the arbitrage server obtains the energy supply data in substantially real-time.

4. The system according to claim 1, wherein the different pre-defined regions are each associated with different electric utility companies and wherein the same pre-defined region is associated with a single electric utility company.

5. The system according to claim 1, wherein the arbitrage server further includes instructions that, when executed by the processor, cause the processor to present energy purchasing preferences for selection by a user.

6. The system according to claim 1, wherein the arbitrage server further includes instructions that, when executed by the processor, cause the processor to present a cost range for purchasing power for selection by a user.

7. The system according to claim 1, further comprising an application server that aggregates the power consumption data for the plurality of power management devices provided within the same pre-defined region.

8. A computer-implemented method of performing energy arbitrage among different pre-defined regions, the method comprising:
obtaining, via a processor, power consumption data from corresponding customer facilities located within the different pre-defined regions;
aggregating the power consumption data associated with a plurality of power management devices to determine a total power consumed within a same pre-defined region;
obtaining energy supply data to determine a total power supplied to the same pre-defined region;
comparing the total power consumed and the total power supplied within the same pre-defined region;
offering to sell energy to a different pre-defined region when the total power supplied exceeds the total power consumed; and
offering to purchase energy from the different pre-defined region when the total power consumed exceeds the total power supplied.

9. The computer-implemented method according to claim 8, wherein the power consumption data is obtained from the corresponding customer facilities in substantially real-time.

10. The computer-implemented method according to claim 8, wherein the energy supply data is obtained in substantially real-time.

11. The computer-implemented method according to claim 8, wherein the different pre-defined regions are each associated with different electric utility companies and wherein the same pre-defined region is associated with a single electric utility company.

12. The computer-implemented method according to claim 8, further comprising presenting energy purchasing preferences for selection by a user.

13. The computer-implemented method according to claim 8, further comprising presenting a cost range for purchasing power for selection by a user.

14. The computer-implemented method according to claim 8, wherein aggregating the power consumption data associated with the plurality of power management devices is performed within the same pre-defined region.

15. A non-transitory computer-readable storage medium having stored therein instructions which, when executed by an electronic device, cause the electronic device to:
obtain, via a processor, power consumption data from corresponding customer facilities located within the different pre-defined regions;
aggregate the power consumption data associated with a plurality of power management devices to determine a total power consumed within a same pre-defined region;
obtain energy supply data to determine a total power supplied to the same pre-defined region;
compare the total power consumed and the total power supplied within the same pre-defined region;
offer to sell energy to a different pre-defined region when the total power supplied exceeds the total power consumed; and
offer to purchase energy from the different pre-defined region when the total power consumed exceeds the total power supplied.

16. The non-transitory computer-readable storage medium of claim 15, wherein the power consumption data is obtained from the corresponding customer facilities in substantially real-time.

17. The non-transitory computer-readable storage medium of claim 15, wherein the energy supply data is obtained in substantially real-time.

18. The non-transitory computer-readable storage medium of claim 15, wherein the different pre-defined regions are each associated with different electric utility companies and wherein the same pre-defined region is associated with a single electric utility company.

19. The non-transitory computer-readable storage medium of claim 15, wherein the computer-readable storage medium stores further instructions that, when executed by the electronic device, cause the computing device to present energy purchasing preferences for selection by a user.

20. The non-transitory computer-readable storage medium of claim 15, wherein the computer-readable storage medium stores further instructions that, when executed by the electronic device, cause the computing device to present a cost range for purchasing power for selection by a user.
